(19) United States
(12) Patent Application Publication
(10) Pub. No.: US 2025/0097338 A1
(43) Pub. Date: Mar. 20, 2025

(54) Systems and Methods for Emergency Contact and Response

(71) Applicant: Michelle Candelaria Cooper, Mesa, AZ (US)

(72) Inventor: Michelle Candelaria Cooper, Mesa, AZ (US)

(21) Appl. No.: 18/883,811

(22) Filed: Sep. 12, 2024

Related U.S. Application Data
(60) Provisional application No. 63/582,718, filed on Sep. 14, 2023.

(51) Int. Cl. H04M 1/72424; G06F 40/174; G06V 20/40; G10L 15/26; G10L 25/57; H04M 1/72436; H04M 1/72439; H04M 1/72457; H04N 5/91

(52) U.S. Cl. CPC H04M 1/72424; G06F 40/174; G06V 20/41; G10L 15/26; G10L 25/57; H04M 1/72436; H04M 1/72439; H04M 1/72457; H04N 5/91

(57) ABSTRACT

The system and method for communicating with emergency services includes a front end system and a back end system. The front end system has a user interface that allows a front end user to initiate contact with emergency services through text, video, or voice, auto-populate the front end user's 3D Geolocation, and to initiate a livestream of the surroundings. The back end system is adapted to allow an emergency response officer to view live stream videos remotely, communicate with a front end user via text, video, or voice, submit links and other information to the front end user, and log the location of the front end user. The back end system utilizes automated identification capabilities, being able to perform an automatic identification of sounds, objects, or entities in a recording. The system further produces a police report to summarize the event and store all relevant information for future reference.

### FIELD OF THE INVENTION

The present invention relates generally to communication. More specifically, the present invention is an improved system and method for communicating with emergency services.

### BACKGROUND OF THE INVENTION

Quick and accurate communication is of paramount importance in emergency scenarios. The current standard for emergency contact is phone calls, which result in an audio-only communication. This can leave emergency response personnel slow to respond, as they must collect information in conversation regarding the location, situation, and severity of the situation. Further, evidence that may be necessary for further proceedings may be difficult to collect with only a phone recording of the situation. There thus exists a need for an improved system and method for emergency contact and response.

The present invention aims to solve this problem by providing an improved system and method for communicating with emergency services. The communication system includes a front end system 1 and a back end system 2. The front end system 1 comprises a user interface adapted to allow a front end user to initiate contact with emergency services through text, video, or voice, auto-populate the front end user's 3D Geolocation, and to initiate a video livestream of the surroundings. The back end system 2 is adapted to allow an emergency response officer to view live stream videos remotely, communicate with a front end user via text, video, or voice, submit links and other information to the front end user, and log the location of the front end user. In some embodiments, the back end system 2 is adapted with automated identification capabilities, being able to perform an automatic identification of sounds, objects, or entities in a recording. When an interaction is conclude, the system produces a police report to summarize the event and store all relevant information for future reference.

As described above, the present invention provides an improved system and method for facilitating emergency response communications.

### BRIEF DESCRIPTION OF THE DRAWINGS

FIG. 1 is a system diagram of the present invention.

FIG. 2 is a system diagram of the front end system of the present invention, showing an exemplary embodiment of some functionalities.

FIG. 3 is a system diagram of the back end system of the present invention, showing an exemplary embodiment of some functionalities.

FIG. 4 is a method flowchart of the present invention, showing an exemplary method for a front end user initiating a livestream.

FIG. 5 is a method flowchart of the present invention, showing an exemplary method for a front end user initiating a text conversation.

FIG. 6 is a method flowchart of the present invention, showing an exemplary method for a back end user requesting a livestream.

FIG. 7 is a method flowchart of the present invention, showing an exemplary method for performing objection identification and speech-to-text analysis.

### DETAILED DESCRIPTION OF THE INVENTION

All illustrations of the drawings are for the purpose of describing selected versions of the present invention and are not intended to limit the scope of the present invention.

The words “a”, “an” and “the”, should be construed to include both the singular and plural. For example, reference to “a component” should be read to include “one or more” of the component. Unless otherwise explicitly stated, it should be understood that any communication and transfer of data between components is done using systems and methods well-known in the art, including but not limited to: communication over a network such as the internet using information packets, using Wi-Fi, wired connections, Bluetooth, or any other electronic communication mechanism that is well-known in the art. The words “3D geolocation” should be understood to refer ideally to the 3D geolocation, but should also be construed to encompass any similar geolocation or locating technique that is well-known in the art.

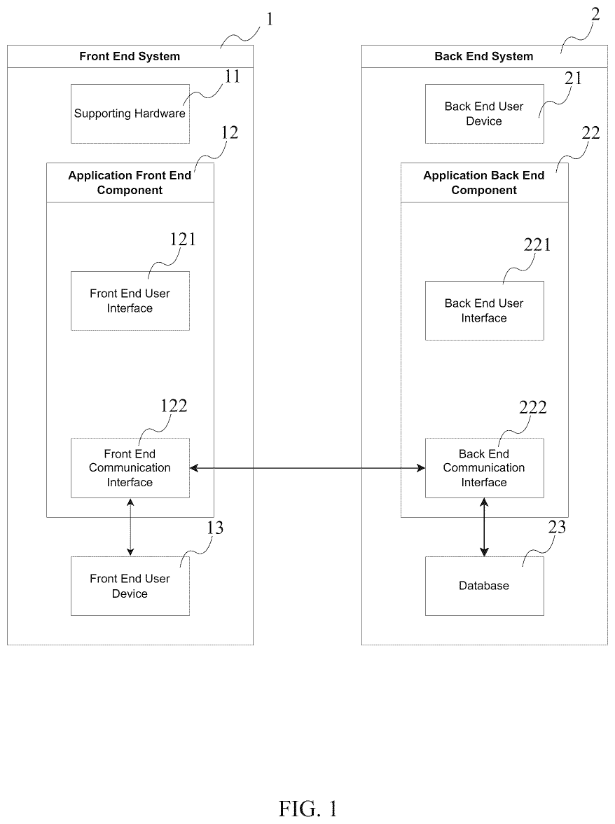

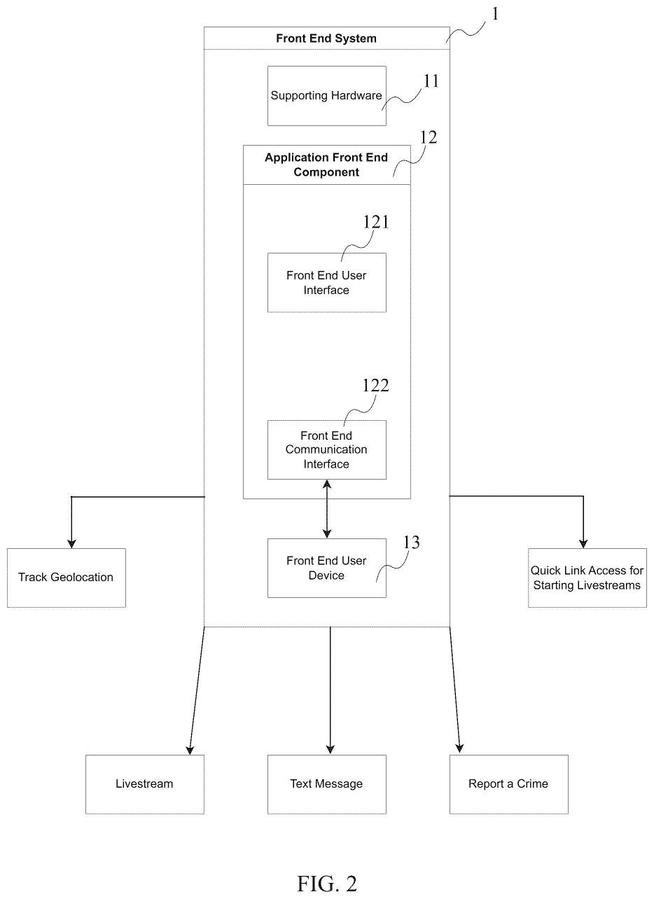

The present invention is an improved system and method for emergency contact and response. The present invention comprises a front end system 1 and a back end system 2. As seen in FIG. 1-2, the front end system 1 further comprises a front end user device 13, an application front end component 12, and at least one supporting hardware 11. The front end user device 13 comprises a laptop, mobile device, or other similar electronic device that comprises both processing and communication components for communication over a network as is well-known in the art. The application front end component 12 further comprises a front end user interface 121 and a front end communication interface 122. The front end user interface 121 is adapted to accept front end user input using the front end user device 13, for example, by accepting input from a keyboard, mouse, touch device, or similar input device. The front end user interface 121 is adapted to allow a front end user to initiate contact with emergency services. The front end communication interface 122 is adapted to connect the front end system 1 to the back end system 2, allowing the transfer of data over a network to the back end system 2. The application front end component 12 provides multiple functionalities, including but not limited to the functionalities described below: initiating contact with emergency services, transmitting information to emergency services, and permitting a front end user to upload evidence.

To initiate contact with emergency services, the application front end component 12 prompts a front end user with an emergency text prompt to enter a text message to the emergency services. In the ideal embodiment, the emergency text prompt auto-populates a front end user's 3D Geolocation using any relevant 3D Geolocation information available on the front end user device 13, such as a GPS location. A front end user may also manually enter or change this information. To initiate contact with emergency services, the application front end component 12 also prompts a front end user to enter a phone number, or auto populates the phone number and 3D Geolocation. Once a front end user confirms the request, the application front end component 12 starts a video to livestream the surroundings using any relevant video or recording componentry present on the front end user device 13. The livestream is sent directly to the back end system 2 for review by an emergency services officer.

To upload evidence, the application front end component 12 also prompts a front end user to submit any evidence for an incident. The application front end component 12 adapts to accept video files, such as a recording of the incident, testimony recorded after the fact, or any other relevant video information. The application front end component 12 further adapts to accept any other relevant information, including audio recordings, text testimony or recording, or any similar information in any format that is relevant to the proceedings. Information is transmitted to the backend and stored on a storage device, such as a database 23.

In reference to FIG. 2, the application front end component 12 is further configured to continuously monitor the front end user's 3D Geolocation. The application front end component 12 uses satellite tracking, GPS tracking, or any other method well-known in the art for extracting a 3D Geolocation from the front end user device 13. The 3D Geolocation is automatically recorded and sent to the back end system 2 at various intervals or when a specific condition is met, such as any time a communication is sent to the back end system 2. The back end system 2 stores a log of 3D Geolocations, each 3D Geolocation being linked to a time, incident, or an action taken by the front end user. The application front end component 12 is configured to start a livestream with the front end user device 13.

The application front end component 12 is further configured to start a livestream using the front end user device 13 when provided with a livestream link. When a front end user clicks the livestream link, the application front end component 12 automatically starts a livestream using any audio or visual recording devices present on the front end user device 13. The livestream is immediately transmitted to the back end system 2, where it is displayed for viewing and recording by emergency services. The one or more supporting hardware comprises a video camera such as a mobile phone, laptop, tablet, dashcam, audio recorder, location tracking device, or any other similar hardware that is adapted to facilitate the functions of the application front end component 12 described herein by recording and transmitting data. The application front end component 12 is furthermore configured to receive a text message from the front end user. As a result, the front end user can communicate with a back end user via text messages or another communication means. The application front end component 12 is configured to report a crime, wherein the front end user can access the front end user interface 121 to make note of an incident.

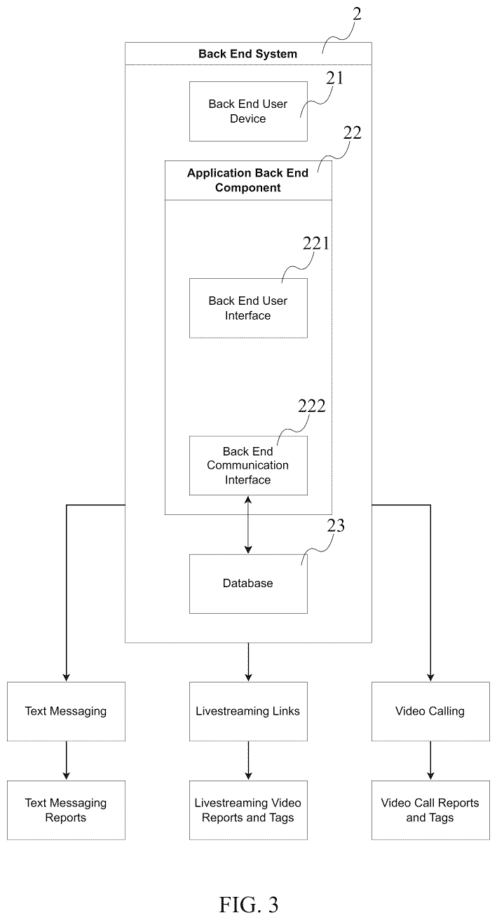

Referring now to FIG. 1 and FIG. 3, the back end system 2 comprise a back end user device 21, an application back end component 22 and a database 23. The application front end component 12 is coupled to the application back end component 22 to allow emergency services to interact with the application front end component 12. The application front end component 12 and the application back end component 22 form an application accessible through an electronic device. The application back end component 22 further comprising a back end user interface 221 and a back end communication interface 222 adapted to allow the application back end component 22 to communicate with a front end user, similar to the application front end component 12. The back end system 2 is used by a back end user, the back end user ideally being an emergency response official such as a police officer or 911 operator.

The back end user device 21 comprises a laptop, mobile device, or other similar electronic device that comprises both processing and communication components for communication over a network as is well-known in the art. In the ideal embodiment, the back end user device 21 is a portable device that an emergency services official situates in their vehicle to allow for rapid response while on the job. The database 23 is any storage medium well-known in the art, such as a conventional database 23, solid state drive, hard drive, or other any storage medium that is adapted to send and receive data to a network.

In reference to FIG. 3, the back end user device 21 implements the application back end component 22. The application back end component 22 is configured to send and receive data to the database 23 and the application front end component 12 using the back end communication interface 222. Some exemplary functionality of the application back end component 22 is described below. The application back end component 22 is configured to allow a back end user, such as an emergency services official, to log in from a remote location, for example, from a police patrol vehicle. The application back end component 22 is configured to allow a back end user to interact with a front end user, view live stream videos from a front end user, send and receive text messages from a front end user, and make and receive calls with a front end user. The application back end component 22 is configured to allow a back end user to send a link requesting a live stream to a front end user. When the front end user clicks on the link, a livestream is automatically started by the front end user device 13 and transmitted to the application back end component 22, where it is displayed for the back end user using the back end user device 21. In some embodiments, the back end user device 21 is configured to allow the back end user to send a two-way call link request to the front end user. When the front end user clicks the link, the application front end component 12 automatically initiates a two-way audio or video call between the front end user and the back end user. As described above, the application back end component 22 is configured to store 3D Geolocations associated with an interaction. For example, any text messages sent from a front end user may be automatically tagged with a 3D Geolocation, and the contents of the text and associated 3D Geolocation are stored in the database 23. 3D Geolocations should also be understood to be stored and tagged for any interaction, including but not limited to livestreams, videos, photos, calls, texts, and any other information being transmitted from the front end user device 13.

In reference to FIG. 3, In the ideal embodiment, the application back end component 22 is configured to allow the back end user to both remain on a call with an individual and send texts to the individual simultaneously, to improve communication in situations where a front end user is unable to talk.

In some embodiments, the application back end component 22 is adapted to perform object identification. The application back end component 22 is adapted to analyze a video with custom code to identify routine objects. For example, the application back end component 22 is adapted to analyze a video file or livestream, identifying any objects or entities in each frame. The objects or entities is tagged, and each tag is then saved in the database 23 and associated with a timestamp of the video as a log of tags. The log of tags is adapted to be searchable by the back end user, allowing a back end user to quickly and efficiently identify any frames in which relevant information might appear. For example, a back end user can search for the tag “dog”, and a list of all frames in which a dog is identified will be returned to the back end user. In some embodiments, the object identification further comprises sound identification. Sounds are identified using custom code—for example, the sound identification can mark and tag any frame in which a specific sound is present, such as identifying a “gun shot”. In some embodiments, the sound identification are adapted with a speech to text function, to automatically analyze the video and transcribe any speech into text that is stored separately or presented alongside the video. Further, the speech to text function is adapted to receive audio input from the back end user, such that the back end user dictates a text message to be sent to the front end user, for example.

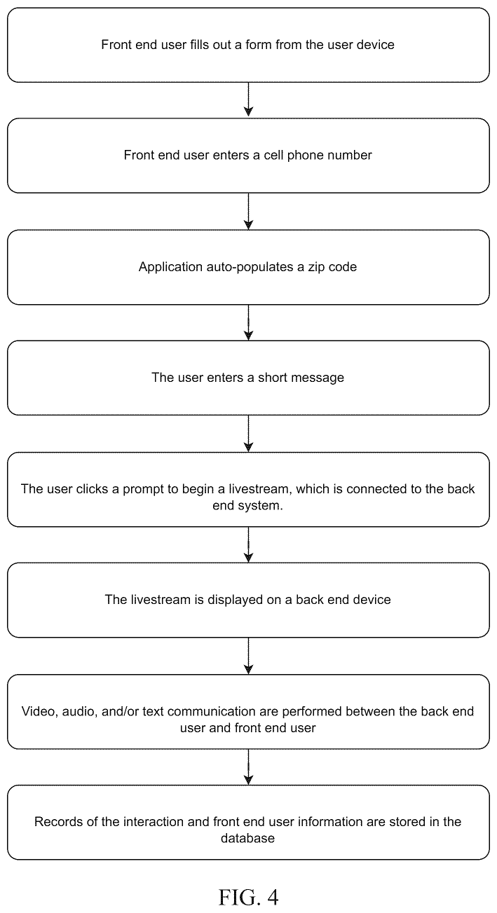

FIG. 4-7 show exemplary methods of use of the systems described herein. FIG. 4 shows a flowchart of an exemplary embodiment of a front end user initiating a call to a back end user. The front end user first fills out a form from their front end user device 13, using the front end user interface 121 of the application front end component 12. The front end user enters a cell phone number, and the application front end component 12 auto-populates the zip code, using either a pre-entered zip code or making use of any 3D Geolocation functions on the front end user device 13. Next, the front end user enters a short message describing the situation or any requests. The front end user then clicks a prompt to begin a livestream, the livestream being transmitted and displayed on a back end user device 21 for a back end user. The back end user then enters into video, audio, and/or text communication with the front end user while observing the live stream. Once the interaction is completed, records of the interaction (such as video logs, audio logs, 3D Geolocations, etc.) is recorded and stored in the database 23.

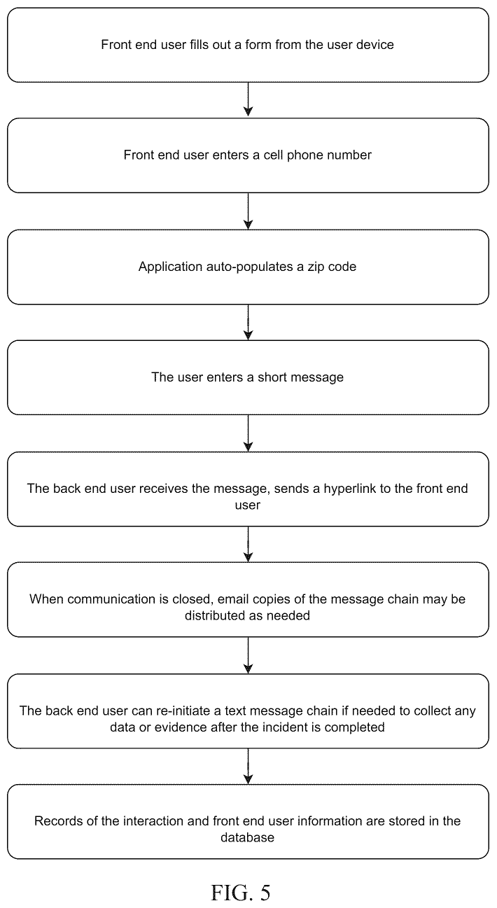

Referring now to FIG. 5, an exemplary method of a front end user initiating a text conversation with a back end user is shown. The front end user first fills out a form from their front end user device 13, using the front end user interface 121 of the application front end component 12. The front end user enters a cell phone number, and the application front end component 12 auto-populates the zip code, using either a pre-entered zip code or making use of any 3D Geolocation functions on the front end user device 13. Next, the front end user enters a short message describing the situation or any requests. The front end user clicks a prompt to send the message, and this will initiate two-way text communication between the front end user and a back end user, wherein the livestream is displayed on the back end user device 21. This allows for the front end user to communicate with the back end user. Once communication is closed, email copies of the message chain is distributed as needed, to front end user, back end users, the database 23, or other recipients. Contact information of the front end user is stored in the database 23 following the conversation, such that a back end user re-initiates a text message chain as needed, such as to collect post-incident testimony. Once the interaction is completed, records of the interaction (such as video logs, audio logs, 3D Geolocations, etc.) is recorded and stored in the database 23.

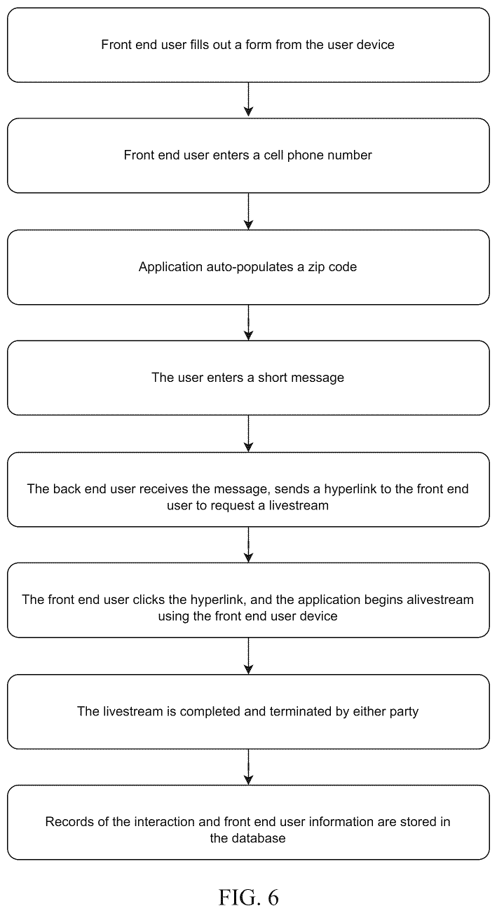

Referring now to FIG. 6, an exemplary method for a back end user to request a live stream is described. The front end user first fills out a form from their front end user device 13, using the front end user interface 121 of the application front end component 12. The front end user enters a cell phone number, and the application front end component 12 auto-populates the zip code, using either a pre-entered zip code or making use of any 3D Geolocation functions on the front end user device 13. Next, the front end user enters a short message describing the situation or any requests. The front end user clicks a prompt to send the message to the back end user. Once the back end user receives the message, the back end user transmits a hyperlink or prompt to the front end user. When the front end user clicks on the hyperlink, the application front end component 12 will initiate a live stream on the front end user device 13 and immediately transmit the live stream to the back end user. In some embodiments, clicking on the link also initiates two-way communications with the back end user, either being text, video, and/or audio communications. Either party terminates the livestream, at which point records of the interaction (such as video logs, audio logs, 3D Geolocations, etc.) is recorded and stored in the database 23.

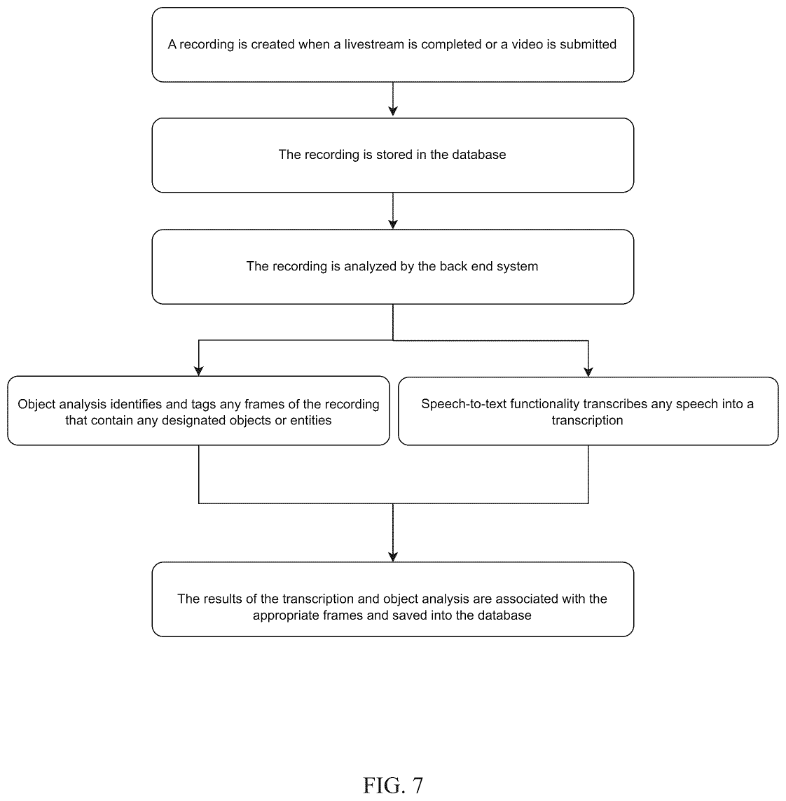

FIG. 7 shows an exemplary method of analysis of recorded data. A recording is created when a livestream is completed or a video is submitted. The recording is stored in the database 23 of the back end system 2. The recording is then analyzed by the back end system 2 using custom code. Object analysis is performed on a video recording, identifying and tagging any frames of the recording that contain any designated objects or entities. Objects and entities is selected from a pre-designated set of entities and the tags auto-generated upon submission of the recording, or a back end user manually specifies what objects/entities should be tagged in the recording. In some embodiments, the analysis of recorded data further comprises speech-to-text functionality. Any audible speech in the recording is transcribed into a transcription, and the transcription is matched to the timing of the recording and stored in the database 23.

Although the invention has been explained in relation to its preferred embodiment, it is to be understood that many other possible modifications and variations can be made without departing from the spirit and scope of the invention.

What is claimed is:

1. A system for emergency contact and response comprising:
a front end system;
a back end system;
the front end system comprising at least one supporting hardware, an application, and a front end user device;
the back end system comprising a back end user device, an application back end component, and a database;
the application further comprising a user interface and communication interface; and
the application back end component comprising a back end user interface and a back end communication interface.

2. The system for emergency contact and response as claimed in claim 1 wherein:
the application is configured to track the geolocation of the user;
the application is configured to start a livestream using the front end user device;
the application is configured to receive a text message from the front end user;
the application is configured to report a crime; and
the application is configured to provide the user with a hyperlink for starting livestreams.

3. The system for emergency contact and response as claimed in claim 1 wherein:
the application back end component is configured to send and receive data to the database;
the application back end component is configured to allow an emergency services official to log in from a remote location;
the application back end component is configured to allow a back end user to interact with a front end user;
the application back end component is configured to store geolocations associated with a front end user interaction; and
the application back end component is configured to allow a back end user to send a link requesting a live steam to a front end user.

4. The system for emergency contact and response as claimed in claim 3 wherein:
the application back end component is configured to send and receive text messages between the front end user and the back end user;
the application back end component is configured to make and receive calls between the front end user and the back end user; and
the application back end component is configured to view live stream videos from a front end user.

5. The system for emergency contact and response as claimed in claim 4 wherein the application back end component is configured to allow the back end user to remain on a call and send text to a front end user simultaneously.

6. A method for operating an emergency contact and response system comprising:
a front end system;
a back end system;
the front end system comprising supporting hardware, and application, and a front end user device;
the back end system comprising a back end user device, an application back end component, and a database;
the application further comprising a user interface and communication interface;
the application back end component comprising a back end user interface and a back end communication interface;
the front end user, using the application, filling out a form on the front end user device;
the front end user, using the application, entering a cell phone number;
the application, auto-populating the zip code for the front end user, based on the entered cell phone number;
the front end user, using the application, entering a short text message;
the front end user, using the user interface, clicking a prompt to begin a livestream which is connected to the back end system;
the livestream displaying on the back end user device;
the front end user communicating with the back end user; and
the back end user, using the database, storing the front end user information and records of the interaction between the front end user and back end user.

7. A method for operating an emergency contact and response system as claimed in claim 6 comprising:
the front end user, using the application, filling out a form on the front end user device;
the front end user, using the application, entering a cell phone number;
the application, auto-populating the zip code for the front end user, based on the entered cell phone number;
the front end user, using the application, entering a short text message;
the front end user, using the application, communicating with the back end user;
distributing the communication record to the database, front end user device, or back end user device;
the back end user, using the application back end component, reinitiating the communication with the front end user, to obtain data or evidence; and
the back end user, using the database, storing the front end user information and records of the interaction between the front end user and back end user.

8. A method for operating an emergency contact and response system as claimed in claim 6 comprising:
the front end user, using the application, filling out a form on the front end user device;
the front end user, using the application, entering a cell phone number;
the application, auto-populating the zip code for the front end user, based on the entered cell phone number;
the front end user, using the application, entering a short text message;
the back end user, using the application back end component, receiving the short text message;
the back end user, using the application back end component, sending a hyperlink to the front end user to request a livestream;
the front end user, using the application, clicking the hyperlink;
the front end user, using the front end user device, beginning a livestream;
terminating the livestream, using the front end user device or the back end user device; and
storing, using the database, records of the interaction and front end user information.

9. A method for operating an emergency contact and response system as claimed in claim 6 comprising:
the back end user, using the application back end component, recording the livestream;
the back end user, using the database, storing the livestream recording; and
analyzing, using the back end system, the livestream recording.

10. A method for operating an emergency contact and response system as claimed in claim 9 comprising:
performing object analysis on the livestream recording;
identifying and tagging frames of the livestream recording containing designated objects or entities;
selecting objects or entities from a pre-designated set; and
associating and saving, using the database, the results of the object analysis with the appropriate frames.

11. A method for operating an emergency contact and response system as claimed in claim 9 comprising:
performing speech to text analysis on the livestream recording;
transcribing speech from the livestream recording; and
associating and saving, using the database, the results of the speech to text analysis with the appropriate frames.
